(19) United States
(12) Patent Application Publication
(10) Pub. No.: US 2026/0104688 A1
(43) Pub. Date: Apr. 16, 2026

(54) PRE-SINGULATED METAL CARD TEMPLATE FOR ACCELERATED SINGULATION AND WASTE REDUCTION

(71) Applicants: Aaron Christian Tucker, Cincinnati, OH (US); Jason J. Yost, Roscoe, IL (US)

(72) Inventors: Aaron Christian Tucker, Cincinnati, OH (US); Jason J. Yost, Roscoe, IL (US)

(21) Appl. No.: 19/228,721

(22) Filed: Jun. 4, 2025

Related U.S. Application Data
(60) Provisional application No. 63/656,088, filed on Jun. 4, 2024.
(60) Provisional application No. 63/714,068, filed on Oct. 30, 2024.
(60) Provisional application No. 63/714,226, filed on Oct. 31, 2024.

(51) Int. Cl. G05B 19/18; G06K 19/077

(52) U.S. Cl. CPC G05B 19/182; G06K 19/0772; G05B 2219/49358

(57) ABSTRACT

A method and system for the manufacturing of metal cards using a pre-singulated card-to-card tabbing structure that eliminates the need for a surrounding frame. The invention enables higher sheet utilization, reduced scrap material, and faster CNC milling by chemically or mechanically defining voids in a metal sheet that correspond to individual cards, each connected to adjacent cards via breakable struts or tabs. Additional features may include selective etching of cavities for magnetic stripes or EMV chips to allow flush mounting without post-assembly surface protrusions. The system supports a variety of card types, including financial, membership, access, and business cards, and accommodates multi-layer construction, resin infill, and lamination techniques. The invention also allows automated or manual insertion of components, enhanced bonding via etched sidewalls, and significant improvements in production efficiency, tool longevity, and final product durability.

### RELATED APPLICATIONS

This application claims priority to U.S. Provisional Application No. 63/656,088, filed Jun. 4, 2024, entitled METAL FRONT AND REAR SMARTCARD FOR TRANSMISSION OF INFORMATION, by Aaron Christian Tucker, et al.; U.S. Provisional Application No. 63/714,068, filed Oct. 30, 2024, entitled PRE-SINGULATED METAL CARD TEMPLATE FOR ACCELERATED SINGULATION AND WASTE REDUCTION, by Aaron Christian Tucker, et al.; and U.S. Provisional Application No. 63/714,226, filed Oct. 31, 2024, entitled ETCHED MAGSTRIPE INTEGRATION FOR METAL TRANSACTION CARDS, by Aaron Christian Tucker, et al., the contents of which are incorporated herein by reference.

### TECHNICAL FIELD

The present disclosure relates generally to information carrying cards such as smartcards, credit cards, or other transaction cards, and, more particularly, to a pre-singulated metal card template for accelerated singulation and waste reduction, illustratively for metal transaction cards with a single layer of metal or a plurality of layers of metal (e.g., metal front and rear transaction cards).

### BACKGROUND

The concept of credit and payment cards dates back to the early 20th century when the first metal charge card was introduced in 1914. Plastic cards only started to gain popularity in the 1950s, and later became the material of choice due to its durability, ease of manufacture, and cost-effectiveness. This allowed for widespread adoption and standardization of payment cards.

Early credit cards featured raised (embossed) numbers that allowed merchants to take imprints using manual imprinters, commonly known as “knuckle-busters.” This technology was simple yet effective for its time, enabling the transfer of card information onto carbon paper receipts. In the 1970s, the magnetic stripe was introduced, revolutionizing the payment card industry. These strips could store more information, including the cardholder's account number, name, and expiration date. This allowed for electronic data capture, reducing the risk of fraud and speeding up transaction times.

The next significant advancement came with the introduction of EMV (Europay, MasterCard, and Visa) chip technology in the 1990s. EMV chips embedded microprocessors into the cards, providing enhanced security through dynamic data authentication. Each transaction generated a unique code, making it much harder for fraudsters to replicate.

As technology advanced, Radio-Frequency Identification (RFID) enabled contactless payment methods (e.g., using transponder chip modules or “TCMs”). Introduced in the early 2000s, contactless cards allow users to make payments by simply tapping their cards on a terminal, offering convenience and speed. The latest innovation in payment card technology is the dual interface smartcard, which combines both contact and contactless functionalities. These cards feature an EMV chip and an RFID antenna, allowing users to choose between inserting their card into a reader or tapping it on a contactless terminal.

In recent years, some card issuers have begun offering metal payment cards as a premium alternative to traditional plastic cards. These metal cards, often associated with high-end credit card offerings, are made from materials such as stainless steel, titanium, and other alloys. They are marketed for their durability, distinctive weight, and perceived luxury, appealing to consumers who value exclusivity and status.

While metal cards offer several aesthetic and durability advantages, they also present unique challenges that can affect functionality. For instance, the metal composition of these cards can interfere with the RFID signals necessary for contactless payments, which can result in inconsistent performance or complete failure of the contactless functionality. Additionally, some card readers, particularly older models, are not designed to handle the thicker and more rigid structure of metal cards. This can cause difficulties during the insertion process, leading to wear and tear on both the card and the reader. Moreover, producing metal cards is more complex and expensive compared to plastic cards, as the processes involved in cutting, shaping, and embedding technology into metal are more intricate, leading to higher production costs.

### SUMMARY

According to one or more embodiments described herein, a pre-singulated metal card template is provided that enables accelerated card singulation and dramatically reduces material waste. In contrast to current techniques, where cards are suspended by corner struts to a surrounding metal frame, the present invention uses card-to-card struts or tabs, allowing cards to be interconnected directly with each other in a grid layout. This results in near-zero wasted metal between cards, improves sheet yield, and enables simultaneous dual-edge separation using a single CNC toolpath.

As described herein, each card is partially defined within a metal sheet, in one embodiment using chemical etching, to remove the boundary metal while leaving minimal, strategically placed tabs at the edges where adjacent cards meet. These tabs maintain structural stability during subsequent processes (printing, lamination, embedding) and are easily milled away during final singulation. In some embodiments, magnetic stripe and chip cavities are also chemically etched prior to lamination, streamlining final production.

In one embodiment, for instance, the present invention is directed toward etched magstripe integration for metal transaction cards, and in particular, to a method for integrating a magnetic stripe into a metal transaction card, comprising: etching a cavity into the metal card's surface to accommodate the magnetic stripe; applying an adhesive within the etched cavity; and embedding the magnetic stripe within the adhesive-coated cavity, ensuring the stripe sits flush with the card surface.

Other embodiments of the present disclosure may be discussed in the detailed description below, and the summary above is not meant to be limiting to the scope of the invention herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates a pre-singulated metal card sheet with card-shaped voids defined by chemical etching and connected via card-to-card tabs without a surrounding frame;

FIG. 2 illustrates an alternative illustration of FIG. 1;

FIG. 3 illustrates a 2×2 sheet;

FIG. 4 illustrates a flowchart depicting an example manufacturing method for producing pre-singulated metal card sheets, including sheet preparation, etching, and milling;

FIG. 5 illustrates a magnified view of the card-to-card tab being CNC milled;

FIG. 6 illustrates a metal card with pre-etched magstripe cavities;

FIG. 7 illustrates a schematic showing a sheet of pre-etched magstripe cavities; and

FIG. 8 shows a side view of a metal card with pre-etched magstripe cavities.

### DESCRIPTION OF EXAMPLE EMBODIMENTS

As noted above, payment cards have evolved from simple plastic cards with embossed numbers to sophisticated dual interface smartcards, reflecting advancements in technology aimed at enhancing security and convenience. However, while metal cards offer a luxurious alternative for many consumers, their practical drawbacks highlight the ongoing need for innovation in payment card technology.

In particular, the evolution of transaction cards has progressed from embossed plastic cards to high-security dual-interface smartcards integrating both contact and contactless functionalities. In recent years, metal cards have emerged as a premium offering, lauded for their durability, weight, and aesthetic value. However, their manufacture poses challenges in terms of precision, cost, and throughput. Unlike plastic cards that allow for rapid lamination and punching, metal cards typically require CNC milling to singulate individual cards from a metal sheet, a process that is slow, tool-intensive, and wasteful.

Singulating cards, in particular, refers to the process of separating individual cards from a larger sheet or panel during the manufacturing process. Typically, payment cards are produced in large sheets that contain multiple cards. These sheets go through various printing, embedding, and lamination processes to ensure all cards have the necessary features and security elements. The singulation process involves cutting these sheets into individual cards. This is usually done using precision cutting equipment, such as lasers, CNC machines, or die-cutting machines, to ensure that each card meets the exact size and edge quality specifications.

It is important to note that CNC milling of transaction cards composed of different materials (including metal) are prone to slow singulation speeds and damage to the surface of the cards or the components of the construction of the card. The time that the sheets are on a CNC machine is of paramount importance to avoid excessive cost as well as scrap during the CNC machining process. Conventional techniques for metal card manufacturing traditionally employ full sheets of metal with post-lamination CNC singulation, which is slow and wasteful. More recently, manufacturers have learned a technique (developed originally by the current applicant) to use “metal inlays” where each card is suspended by tabs or struts from a rigid frame. Each of these methods leave significant portions of the sheet unused or discarded and are constrained in layout by the need to maintain structural support from the surrounding frame. Furthermore, precision cutting through full metal increases scrap, dulls tools, requires coolant, and imposes limits on sheet density and card yield.

As described in greater detail below, therefore, certain aspects of the invention herein are directed to providing a metal sheet comprising an array of transaction card outlines (e.g., 5×5 grid for 25 cards), where each card is pre-singulated on all sides except at shared edge tabs with adjacent cards. These tabs (or struts) may be positioned at the center or corners of shared edges and are narrow enough to permit rapid removal by a custom CNC end mill configured to separate both adjacent cards in a single tool pass.

This “card-to-card” tab architecture results in the following improvements over traditional methods:
Higher density packing (e.g., 25-up vs. 16-up layouts);
Reduced metal waste (no peripheral frame);
Lower tool wear (shorter cut paths);
Reduced milling heat (less metal removed);
Faster production throughput; and
Universal applicability to all card types and constructions.

The pre-singulated sheets may be aligned front-to-back using alignment holes or fiducials, and bonded with adhesive subassemblies, including optional antennas, chips, or printed layers. Final milling removes only the tabs while also applying chamfered edges, producing complete cards with precision and polish.

Now in greater detail, according to one or more embodiments of the present disclosure, transaction cards may be manufactured using a pre-singulated metal sheet comprising a plurality of card body sites interconnected via card-to-card tabs. These tabs may be formed during a partial singulation process that chemically etches, stamps, or laser-cuts the perimeter of each card from the sheet. Unlike prior approaches that suspend each card from a surrounding metal frame via corner struts or support beams, the inventive structure described herein utilizes inter-card tabbing to define each card in relation to its immediate neighbors. This configuration significantly improves yield, manufacturability, and downstream processing speed, while reducing waste and tool degradation.

The metal composition of the sheets used in the pre-singulation process may vary based on application and desired card properties. Suitable materials include, but are not limited to, 304 or 316 stainless steel, titanium, aluminum, brass, copper alloys, and custom-engineered composite metals. Stainless steel provides cost-effective corrosion resistance and machining stability, while titanium offers a luxury aesthetic with exceptional strength-to-weight ratios. In certain embodiments, the front and rear sheets may comprise different materials to influence acoustics, weight, or visual contrast. All metal substrates may be provided in full-hard, half-hard, or annealed temper, and may undergo preliminary surface treatments, such as sandblasting, chemical passivation, or primer coating, to promote later adhesion or decorative printing.

The tab locations that interconnect adjacent cards may be strategically positioned along shared card edges or corners. In one embodiment, each card may be joined to neighboring cards on all four sides, using one or more tabs per edge. These tabs may be placed symmetrically at midpoints, asymmetrically at offset positions, or in diagonals at card corners, depending on the stability requirements of the sheet and the desired CNC milling path. The tabs themselves may vary in width, length, or cross-section, and are typically formed during the same etching process used to define the card perimeter, ensuring seamless alignment between tabbed and un-tabbed boundaries.

The pre-singulation process may involve one or more cutting techniques depending on sheet thickness, material hardness, and production scale. Chemical etching (e.g., ferric chloride or cupric chloride-based) is especially effective for stainless steel and titanium sheets, allowing for clean, burr-free edges with minimal mechanical stress. The sheet may be masked on one or both sides with a photoresist, exposed to a UV image of the card outlines, and developed to remove unwanted areas before immersion in an etchant bath. For deeper cuts or thicker materials, the sheet may be flipped and etched from the opposing side to ensure through-hole definition. Alternatively, laser cutting (e.g., fiber or CO₂) or water jet cutting may be used for higher-speed operations or for non-etched sheet formats, though these methods typically produce more burr and require post-processing. Stamping with a hardened die may also be used for large-volume runs with consistent tolerances.

The CNC milling process used to finalize singulation may involve a custom-configured end mill that traces a pre-defined toolpath along tab boundaries. In a key advantage of the present disclosure, the card-to-card tab architecture allows the CNC mill to sever two adjacent card edges in a single pass, halving the number of toolpaths required and reducing cycle time. Chamfered or beveled edge treatments may be applied simultaneously using multi-flute tooling or angled cutters. In some embodiments, cryogenic cooling or mist-based lubrication may be employed to avoid heat distortion, although such measures are less critical due to the reduced cutting burden. For stacked sheet constructions, a larger-diameter end mill may be required to ensure clean separation of bonded layers without delamination or deflection.

Sheet orientation and card layout are also addressed in various embodiments. The card grid may be rectangular (e.g., 5×5, 4×6, 6×6, etc.), hexagonal, or staggered, and may accommodate cards in either portrait or landscape orientations. The layout may be optimized to match standard sheet dimensions (e.g., 12×18 inches, A3, or custom rolls), allowing for maximum card yield and minimal edge scrap. Unlike prior inlays that reserve spacing between card bodies for structural struts or alignment zones, the present invention maximizes usable surface area by leveraging direct card-to-card linkage, increasing sheet yield by up to 30% over conventional 16-up or 25-up framed formats.

Notably, the embodiments herein are not limited to financial transaction cards. In various embodiments, the techniques described herein may be applied to the manufacture of premium metal cards used for business cards, loyalty or VIP cards, hotel room keys, access control credentials, membership IDs, commemorative event cards, or branded promotional items. These cards may omit EMV chips or magnetic stripes altogether and instead rely on QR codes, NFC stickers, or simply visual design and engraving. Regardless of the end-use, the core advantage of card-to-card pre-singulation remains relevant for maximizing production efficiency and quality.

In certain implementations, the metal surface may undergo preparatory treatments prior to void or cavity formation. These treatments may include cleaning with solvents or plasma, mechanical polishing, or flame-applied primer coating to promote later ink or adhesive adhesion. For cards requiring detailed artwork, UV-curable digital inks, silkscreen printing, or laser ablation may be applied prior to lamination. When these treatments occur before singulation, care must be taken to ensure that milling operations do not mar the surface; alternatively, final finishing may occur after the cards are fully separated.

After pre-singulation, the sheet may be stacked with additional metal, dielectric, or printed layers depending on the desired card architecture. Alignment between layers may be maintained using registration holes, mechanical jigs, optical fiducials, or vacuum-assisted placement systems. In a preferred embodiment, both the front and rear metal sheets contain identical pre-singulated card outlines and are aligned using matching alignment holes positioned in the sheet margins or tab junctions. A printed inlay, antenna, or thermoset resin layer may be sandwiched between them, forming a multi-layered card blank.

Once aligned, the stacked sheets may be adhered using acrylic adhesives, hot-melt films, pressure-sensitive tapes, or lamination under heat and pressure. Some embodiments may employ UV-activated adhesives or chemical bonding agents that are cured post-assembly. Where precision alignment is critical, mechanical clamping or vacuum platen systems may be used during bonding. The resulting bonded sheet retains the card-to-card tabbed structure, allowing it to be CNC-milled in the same manner as a single metal layer sheet.

In certain embodiments, thermoset resin may be introduced to encapsulate the internal voids of a multi-layered card stack. This resin, which may include polyurethane or epoxy-based chemistries, may be applied by casting, injection molding, or doctor-blade techniques. When cured, the resin fills all internal cavities (e.g., excluding the EMV and magstripe regions if masked), creating a unified substrate with embedded rigidity and thermal stability. CNC milling may then be performed on the resin-filled sheet to remove the card-to-card tabs, with the EMV cavities and slits optionally remaining filled until later punched or removed by post-processing.

The number and placement of tabs may vary based on material strength, sheet thickness, and handling requirements. In some implementations, each card is connected to its neighbors via two tabs per side, resulting in up to eight total tabs per card. In other designs, only one or two tabs per card (e.g., one on each long edge) may be used to facilitate faster cutting. Tabs may be located at corners, midpoints, or distributed unevenly to accommodate specific milling paths or mechanical constraints.

When processing stacked sheets, CNC end mills may differ in geometry or diameter from those used for single-sheet configurations. For example, a 0.020″ end mill may suffice for single-layer metal separation, whereas a 0.040″ or 0.060″ end mill may be required for thicker multi-layered constructs. These end mills may incorporate multiple flutes, cutting edge coatings (e.g., TiN or DLC), or custom profiles for applying a desired chamfer radius or edge polish.

It is also important to note that the thickness and weight of a card (e.g., a single or dual-layer metal card) is paramount. Accordingly, the techniques herein allow the front layer of metal and the back layer of metal's thickness to be at least 0.012″ thick, grossing a total thickness of metal of at least 0.024″. As described above, both layers of metal may be chemically etched to remove the steel between each card leaving only small tabs on each side of the card of a thickness of no thicker than 0.020″ thick that will be removed with a CNC mill while adding a chamfered edge to remove any sharp edges of the metal.

Also, CNC machining of metal cards, metal face, or solid metal smartcards typically requires extensive cooling to successfully cut through the metal with damaging or warping the metal due to overheating. By chemically etching the area around the card prior to singulation according to the present disclosure, the CNC process won't require excessive coolant to singulate the cards.

Notably, some manufacturing of metal cards utilize a slit in the metal from the left edge of the card into the EMV cavity. That is, metal card construction can use the metal layer in a metal card body to function as a coupling frame, where a discontinuity in the form of a slit or slot has been used to facilitate contactless communication. For instance, regarding RFID slit technology, a metal card body can be transformed into an antenna circuit by providing a discontinuity in the form of a slit, slot, or gap in the metal card body which extends from a peripheral edge to an inner area or opening. The concentration of surface current at the inner area or opening can be picked up by another antenna circuit by means of inductive coupling which can drive an electronic circuit such as an RFID chip attached directly or indirectly thereto. The slit may be ultra-fine (less than 50 μm or less than 100 μm), cut with chemically etching or a UV laser, with the debris from the plume removed by ultrasonic or plasma cleaning. (Without a cleaning step after lasing, the contamination may lead to shorting across the slit.) In addition, the slit may be filed with a dielectric to avoid such shorting during flexing of the metal transaction card. The slit may be further reinforced with the same filer such as a resin, epoxy, mold material, repair liquid or sealant applied and allowed to cure to a hardened state or flexible state. The filer may be dispensed or inkjet molded.

Alternatively, there are methods in place and in development to manufacture a durable, scratch-resistant dual interface (DI) metal card or contact metal card which does not require a slit into the metal layer of the production process. Such metal information/transaction cards may comprise two metal layers encompassing an all-in-one subassembly whose elements define the functionality of transmitting the coded information of the card holder to a receiving terminal device (e.g., a “card reader”), such as, but not limited to, financial information to a payment terminal for an approval process. For instance, an example embodiment may utilize an all-in-one assembly of a copper antenna inserted between layers of adhesive and an interference blocker to allow the communication from the EMV chip to the antenna to a payment processing terminal through either a contact-based manner with physical communication to the EMV chip, or via a DI/Contactless manner from at least 25 millimeters from the terminal from the edges of the card via the antenna-based inner layer. This particular illustrative metal card body may thus comprise a metal front and back, where neither the front nor rear metal layer have a slit as noted above.

The process further supports compatibility with lamination workflows, where plastic or film overlay layers may be applied to the card's outer faces to protect artwork or add tactile finishes. This is particularly useful for cards incorporating printed designs, holographic security features, or writable surfaces. Unlike traditional framed sheet constructions, the card-to-card format described herein enables seamless lamination without frame-induced deformation or delamination near corner struts.

For instance, it is a further embodiment of the present disclosure to implement printing techniques by flame treating metal surfaces to add clear or colored UV or heat cured inks. Other logos and designs may be chemically etched into the metal prior to the assembly of the construction.

In one embodiment, a fingerprint resistant coating may be applied on the surface's front and/or bottom sides of the metal core subassembly, and may be applied through the use of flame treated applied primer to adhere printable graphics inks cured through heat or UV specifically onto metal (e.g., where the printed graphics withstand over 100,000 passes of abrasion testing).

That is, one approach used to protect the surface of a metal card is the application of a hard-coated, fingerprint resistant application to protect the printed design or artwork on the front of the card as well as the back of the card language to metal that has no slits added to the metal. The hard coat layer may be applied to a metal card via screen print or curtain coating used to protect the metal card and thus having the hard coat layer as the top and/or bottom layer of the metal transaction card. In general, a hard coat layer may consist of a clear film that can be hot stamped or laminated to a card body assembly, to provide a card surface finish with a high abrasion resistance and high chemical resistance. This film is designed for use on transaction cards, identification cards, transit passes and other similar cards where the film is applied on the card surface. A release carrier layer may be made of a matte polyester film (e.g., having a thickness of 23 μm), as may be appreciated by those skilled in the art.

The alternative to applying a film to a card body assembly or subassembly is screen printing or spraying of an acrylic or lacquer to the surface requiring a protective layer. Such liquid medium can be transformed into a hard coat by the application of heat, typically in an oven.

Moreover, UV printing is a form of digital printing that uses ultra-violet light to dry or cure ink as it is printed. As the printer distributes ink on the surface of a material (called a “substrate”), specially designed UV lamps follow close behind, curing—or drying—the ink instantly. A primer coat may be used to prime the substrate surface to enhance adhesion. UV flexible ink is a liquid which consists of monomers, colorant, additives, photoinitiator and stabilizer. UV hard ink comprises for example of the following elements: acryl acid ester, 1,6-hexanediol diacrylate initiator, additive and quinacridone series pigment. The primer is made up of aliphatic monomer, acrylic oligomer, aromatic monomer, additives and photoinitiator.

In certain embodiments, a thin layer of clear overlay, possibly carrying a magstripe, may be adhered to the rear layer of metal if the customer has specific design requirements such as, but not limited to, security elements, customer personalization information, heat-stamped holograms, digital drop-on-demand (DOD) print or laser applications, and so on.

Additionally, ISO specifications currently require that a certified financial instrument must contain a magnetic stripe and an EMV chip containing the personal information of the card carrier that transmits the card carrier's personal information to a payment terminal for approval. According to one or more embodiments herein, as described in greater detail below, the areas designated for the magnetic strip and the EMV chip may each be chemically etched before the embedding process of each element. This process will again reduce the time necessary that it typically takes to mill away the steel in these areas and also significantly reduce the scrap incurred in the typical milling process. Once the card is completely singulated the card will be ready to use standard EMV embedding equipment to embed the EMV chip into the chemically etched EMV cavity. Also, the magstripe cavity may be chemically etched before the assembly of the construction and may be filled with a heat-activated adhesive to accept the magstripe.

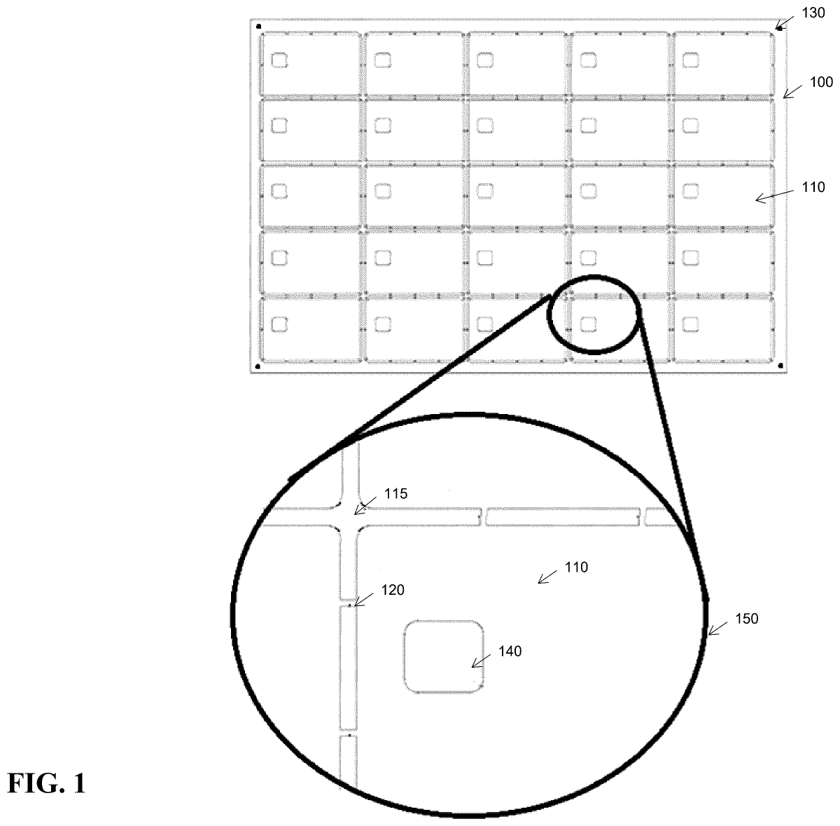

FIG. 1 illustrates an exemplary top-down view of a pre-singulated metal card template according to one embodiment. The sheet 100 includes a 5×5 grid of card outlines (cards 110), with each card perimeter etched (void 115) except for a plurality of tabs (card-to-card tabs 120) positioned along shared card edges. Alignment holes 130 are provided in the sheet margins (outer perimeter) for stacking precision. A designated cavity region 140 is visible on each card to indicate the location of an EMV chip etch. Illustratively the sheet may be 13″ by 18″, though any suitable sheet size may be used.

An exploded view 150 of card bodies (cards 110) supported by multiple card-to-card tabs (card-to-card tabs 120) is also shown. The placement and number of tabs is merely illustrative, and not meant to limit the scope of the embodiments herein.

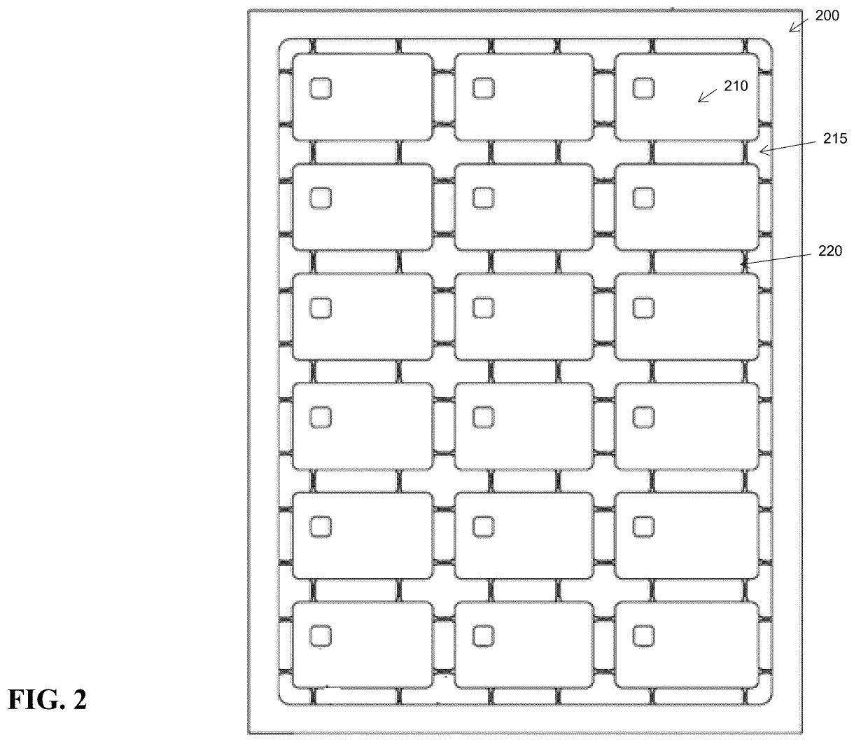

FIG. 2 illustrates an alternative design of a sheet 200 where more space is shown between the cards 210 (voids 215) to emphasis the existence of the card-to-card tabs 220, though it is important to note that in one preferred embodiment herein, the voids are sized to accommodate a single pass of a CNC end mill to cut and chamfer adjacent card bodies, and thus FIG. 2 need not be drawn to scale.

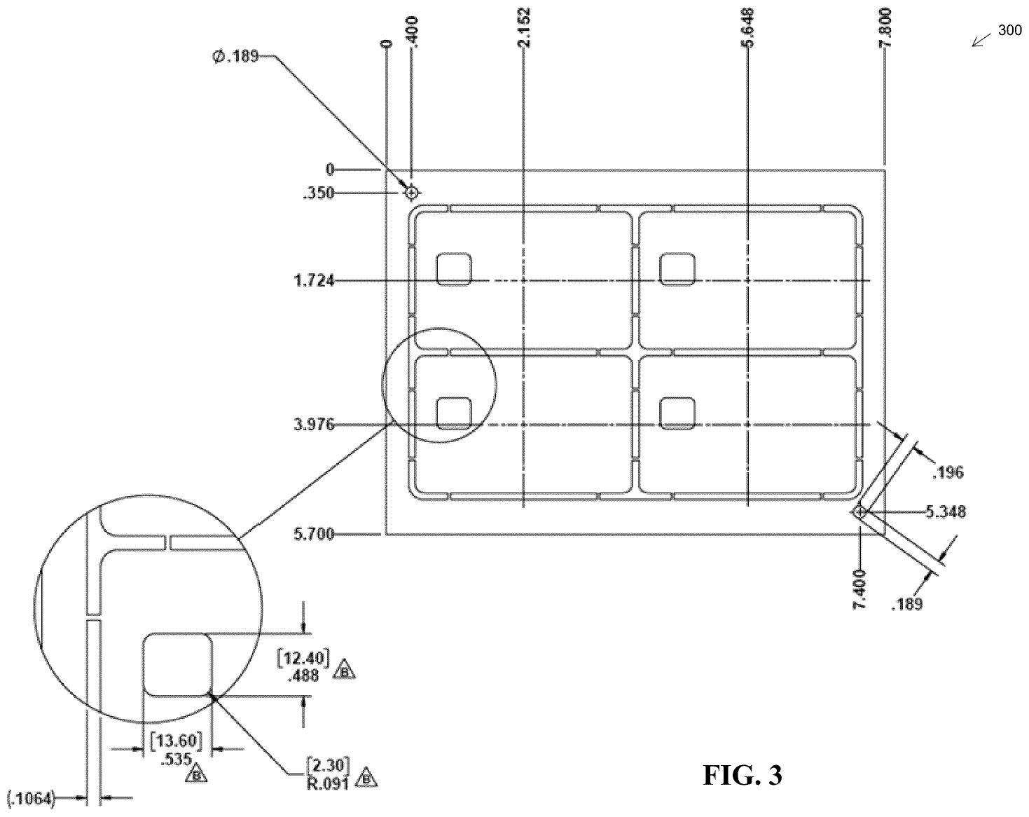

FIG. 3 illustrates an alternative 2×2 mini-sheet layout 300 with example measurements used in pre-singulated metal card manufacturing, in which four card-shaped voids are chemically etched or otherwise pre-cut from a parent metal sheet. The outer perimeter of the metal sheet measures approximately 7.800 inches in length by 5.700 inches in height. Each of the four rectangular card voids represents the standard ISO ID-1 format, corresponding to typical credit card dimensions.

Each card-shaped void includes an embedded rectangular cavity positioned near the upper-left corner (as viewed in the orientation shown). This cavity is designed to accommodate an EMV chip or similar secure hardware module. Notably, the original cavity opening, may illustratively be designed to be 13.60 mm in width and 12.40 mm in height to align with the recommended final milling dimensions of 13.20 mm×12.00 mm as communicated by vendors, ensuring that sufficient tolerance is provided for accurate post-etch milling.

Illustratively, the chip cavity corners may be defined by a corner radius of 0.091 inches (approximately 2.30 mm), facilitating smooth CNC end mill engagement and minimizing stress concentrations in the substrate material. This precise radius was selected based on typical tool dimensions for high-speed steel or carbide end mills, balancing sharp internal corner definition with manufacturability.

Each card void is spaced and supported by a set of tabbed struts, both horizontal and vertical, located between adjacent card edges. The card-to-card configuration eliminates the need for a full frame between or around the voids, instead relying on narrow struts that serve as breakaway or mill-cut bridges during final separation. These inter-card struts are symmetrically placed and of minimal width, allowing for efficient milling passes while preserving positional accuracy across the array.

The mini-sheet includes fiducial holes with a diameter of 0.189 inches, placed at two corners diagonally across from each other to ensure proper registration and alignment within CNC fixtures or handling jigs. One fiducial is offset by 0.400 inches horizontally and vertically from the origin corner, providing a reference for X-Y positioning systems during toolpath initialization.

In this layout, the center-to-center spacing of the card voids is maintained at a consistent 3.976 inches in the horizontal direction and 2.162 inches in the vertical direction. These spacings are calculated to ensure minimal strut widths while avoiding overlapping during tab formation. Overall, the 2×2 configuration serves as a simplified prototype or test batch platform, enabling rapid testing of card features such as chip placement, cavity accuracy, and tab behavior under real-world singulation forces, while adhering to full-scale production tolerances.

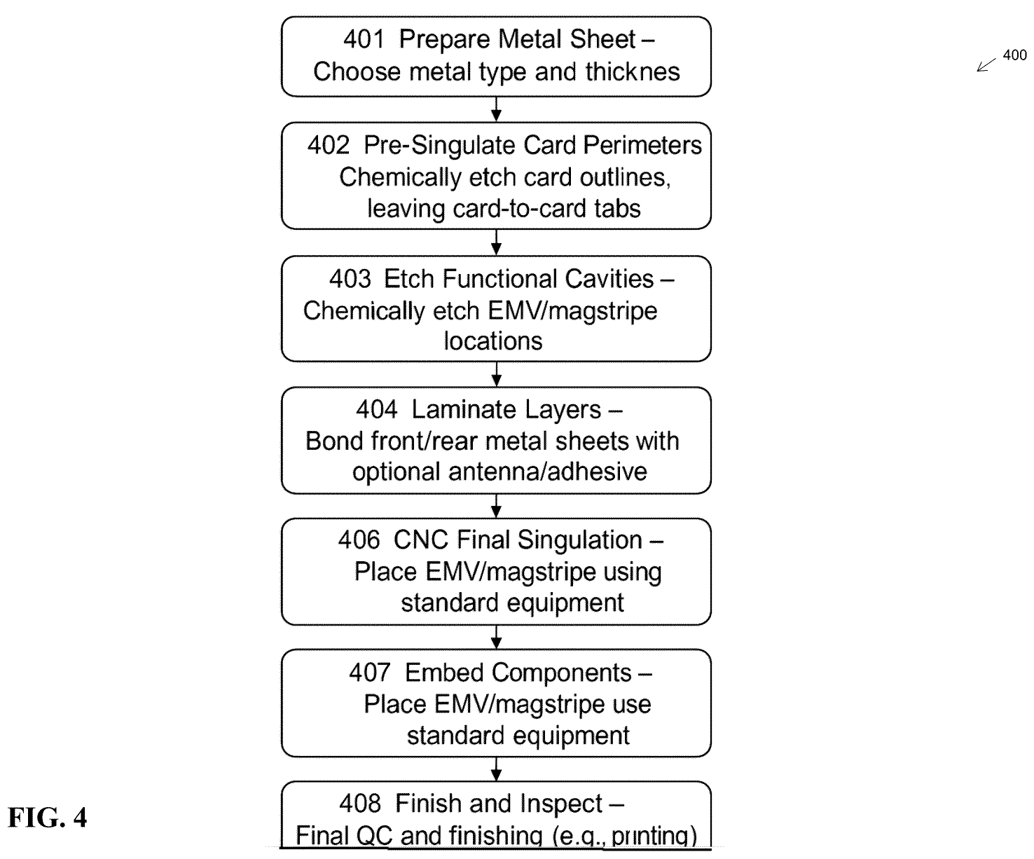

FIG. 4 illustrates an exemplary method 400 for producing pre-singulated transaction cards using a card-to-card tabbed metal sheet configuration, according to one or more embodiments of the present disclosure.

The process begins at Step 401, where a metal sheet is selected and prepared. The metal may be a non-magnetic alloy such as stainless steel (e.g., 304) or titanium, with a thickness chosen to meet ISO card standards when combined with other components (e.g., adhesive layers, inlays). The sheet may be sized to accommodate a predefined array of cards, such as a 5×5 grid yielding 25 cards per sheet.

At Step 402, the metal sheet undergoes a partial singulation process, wherein the outlines of individual card bodies are formed via chemical etching, stamping, or laser cutting. In a distinguishing feature of the invention, each card outline is defined entirely except at discrete tab locations, which connect adjacent cards directly to one another. These card-to-card tabs are positioned at shared edges or corners and are designed to provide mechanical stability during downstream processing.

Following this, Step 403 involves forming cavities to accommodate electronic components. In particular, the EMV chip cavity and magnetic stripe channel are chemically etched into designated regions of the card outline. This approach eliminates the need for subsequent CNC milling to define such features, thereby improving production efficiency and reducing material loss.

Next, at Step 404, the prepared metal sheet is laminated or bonded with additional layers, such as a rear metal sheet, antenna inlay, adhesive films, dielectric blockers, or other subcomponents, depending on the card design.

At step 405, these layers may be aligned using registration holes formed in the metal sheet, ensuring accurate positioning of the stacked components. The bonded construction is then subjected to thermal and/or pressure-based curing to form a cohesive multi-layered card assembly.

In Step 406, the partially singulated cards are fully separated from the master sheet by CNC milling or other cutting techniques that remove only the small tab regions. Notably, a custom-configured end mill may be used to simultaneously remove the tab from both adjacent card edges in a single toolpath. During this operation, chamfered or beveled edge profiles may be applied to enhance card aesthetics and eliminate sharp edges.

Once the individual cards are fully singulated, Step 407 entails embedding electronic components such as the EMV chip and magnetic stripe. Standard embedding equipment may be employed to insert the chip into the pre-etched cavity and to adhere the magnetic stripe into the corresponding channel, typically using a heat-activated adhesive.

Finally, at Step 408, the cards undergo final finishing and inspection. This may include visual quality control, dimensional verification, surface treatments (e.g., hardcoat application, UV-cured graphics), and packaging for distribution. At this stage, each card is a fully formed, ISO-compliant transaction card ready for issuance.

Alternatively stated, a series of steps according to the techniques described herein for pre-singulated card template production may comprise the following:
1. Prepare Metal Sheet—Choose metal sheet material and thickness according to card specifications.
2. Apply Chemical Etching or Stamping—Partially singulate each card by etching or stamping the outline, leaving thin tabs for secure placement.
3. Define EMV and Magstripe Cavities—Chemically etch cavities for the EMV chip and magnetic stripe in compliance with ISO standards.
4. Laminate and Bond Layers—Laminate the front and back metal layers with adhesive, ensuring tabs are aligned.
5. CNC Milling of Tabs—Use CNC milling to remove tabs and apply chamfered edges, separating individual cards from the template.
6. Embed EMV Chip and Magstripe—Use standard embedding equipment to install the EMV chip and magstripe in pre-etched cavities.
   In particular, the production process for a pre-singulated card template may begin with selecting an appropriate metal sheet based on the specified material and thickness for the card design. Once the metal sheet is prepared, a chemical etching or stamping technique is applied to partially singulate each card by defining its outline. This process leaves thin, strategically placed tabs that securely connect each card to the sheet, ensuring stability throughout subsequent manufacturing stages. Next, precise cavities for the EMV chip and magnetic stripe are chemically etched in compliance with ISO standards. This step allows for exact placements of these functional elements, which will be securely embedded later in the production process. After defining these features, the front and back metal layers are laminated and bonded using adhesive, aligning the tabs of each card to maintain structural consistency across the sheet. Following the bonding process, CNC milling is employed to remove the tabs, fully singulating each card from the sheet while simultaneously applying chamfered edges to both adjacent cards in the card-to-card tabbed configuration of the present disclosure. This step gives each card a polished finish and defined boundaries that enhance both aesthetics and usability. Standard embedding equipment may then be used to install the EMV chip and magnetic stripe into the pre-etched cavities, completing the assembly of each transaction card and ensuring that it meets both functional and visual standards. This methodical approach maximizes production efficiency and achieves a premium look and feel for each individual card. The flowchart may then end with a finished product aligned with the techniques described herein, accordingly.

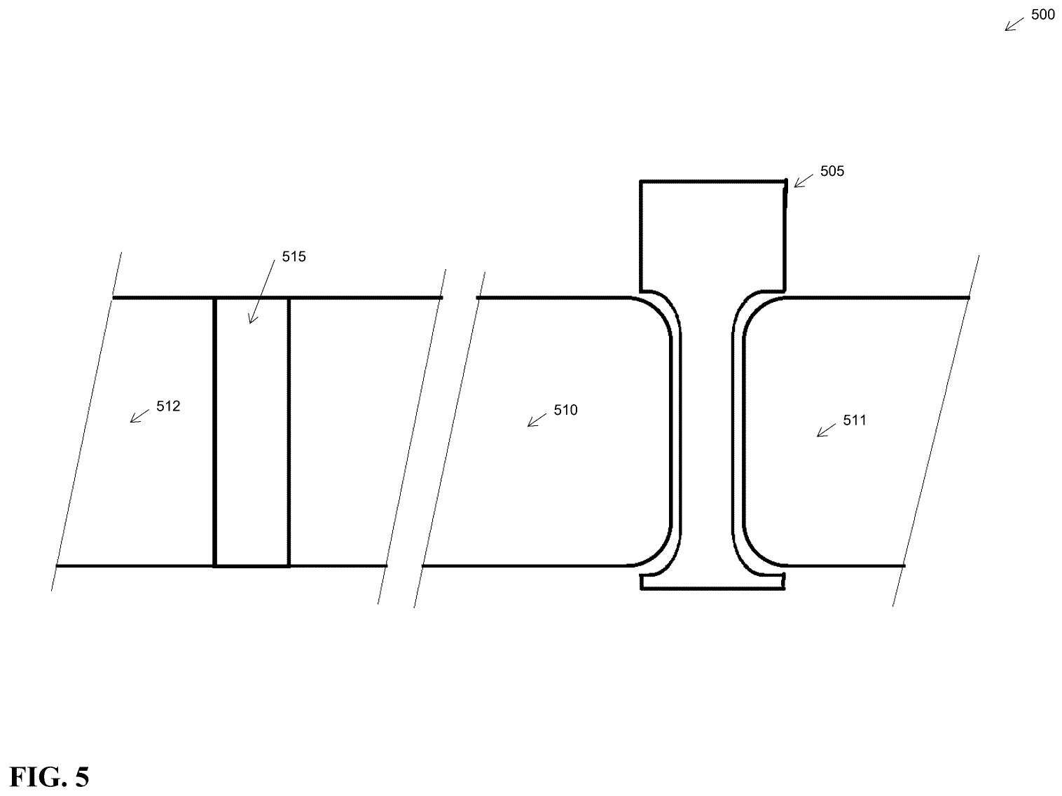

FIG. 5 depicts the CNC toolpath design 500 for singulating card-to-card tabbed sheets. A milling bit 505 traverses between two cards 510 and 511, cutting through the shared tab in a single pass. The dual-edge chamfer is visible along the outer edges, as opposed to the opposing side of the card 510 (adjacent to card 512) that has not yet had tab 515 removed. By synchronizing tab position with CNC motion, highly efficient edge finishing is achieved.

Regarding magnetic stripes (magstripes), unlike plastic cards where the magstripe can be embedded into the card surface through lamination, metal cards often have the magstripe glued to the back, creating an uneven surface. This approach not only affects the card's aesthetics but can also cause the magstripe to wear out more quickly. The present disclosure thus further describes a method to etch out a precise groove or cavity on the metal card's surface, apply adhesive within the etched area, and embed the magstripe smoothly into the card. This technique ensures a flush, durable integration of the magstripe into the metal surface, improving both appearance and functionality. The magstripe pre-etching techniques herein, in particular, may be performed as part of the process to create the voids (e.g., chemical pre-etching) as described above.

That is, certain embodiments of the present disclosure involve etching a precise cavity into the surface of a metal card to accommodate a magnetic stripe, applying adhesive within this etched cavity, and embedding the magstripe so that it aligns flush with the card surface. The result is a seamless, durable integration of the magstripe into the metal card, improving the card's durability, aesthetics, and usability.

The process of embedding a magstripe within a metal card, as described in greater detail below, begins with etching the magstripe cavity. In this step, a controlled etching process creates a precise cavity along the designated area for the magstripe. The depth of the cavity is carefully calibrated to match the thickness of the magstripe, allowing it to sit flush with the card's surface once embedded. Depending on the type of metal and required precision, techniques such as chemical etching or laser engraving are employed. Next, adhesive application involves selecting a specialized adhesive designed to secure the magstripe firmly within the etched cavity. This adhesive is chosen for its durability, capable of withstanding frequent handling, temperature changes, and environmental exposure. It is applied evenly within the cavity, creating a consistent layer to ensure a strong bond and eliminate any potential gaps or uneven surfaces. In the embedding the magstripe stage, the magstripe is carefully positioned within the adhesive-coated cavity, ensuring exact alignment and complete coverage. Once placed, the adhesive is allowed to cure, forming a permanent bond that secures the magstripe within the card and results in a smooth, seamless surface. Finally, during finishing and inspection, the card is thoroughly inspected to verify that the magstripe sits flush with the surface and is securely bonded. To enhance durability and protect the card's appearance, a final protective coating or treatment may be applied, completing the process and ensuring a high-quality, finished product.

For instance, the following is a flowchart of steps according to the techniques described herein for integrating a magstripe into a metal card:
1. Etch Cavity for Magstripe—Create a groove on the metal card surface matching the magstripe's dimensions.
2. Apply Adhesive to Cavity—Coat the etched area with a specialized adhesive.
3. Embed Magstripe—Position the magstripe within the adhesive-coated cavity.
4. Curing Process—Allow adhesive to cure and secure the magstripe in place.
5. Final Inspection—Check that magstripe is flush with the card surface and properly bonded.
   In particular, the process for integrating a magstripe into a metal card begins with etching a cavity for the magstripe, where a precise groove is created on the metal card surface, matching the dimensions and depth of the magstripe. This ensures that the magstripe will sit flush with the card once embedded. Following the etching, adhesive application involves coating the cavity with a specialized adhesive designed for strong, durable bonding. This adhesive layer is applied evenly within the groove to provide a secure base for the magstripe. In the embedding the magstripe step, the magstripe is carefully positioned within the adhesive-coated cavity, ensuring it fits accurately within the etched area. Next, during the curing process, the adhesive is allowed to set, permanently securing the magstripe in place. Finally, a final inspection is conducted to verify that the magstripe is flush with the card's surface and properly bonded. This inspection ensures a smooth, professional finish and a securely integrated magstripe, resulting in a durable and aesthetically pleasing metal card. The flowchart may then end with a finished product aligned with the techniques described herein, accordingly.

Stated differently, in accordance with one or more embodiments of the present disclosure, the surface of the metal sheet may be pre-etched or otherwise recessed at the designated magnetic stripe location to allow for a seamless, flush integration of the magnetic stripe into the card body. Traditionally, magnetic stripes are affixed onto the rear face of a metal card using pressure-sensitive adhesives or lamination techniques. However, when bonded directly onto a flat metal surface, the added thickness of the magstripe creates a protrusion that is not only visually unappealing, but also susceptible to premature wear, delamination, or reader compatibility issues. The present invention overcomes this limitation by introducing a depth-controlled cavity in the metal sheet prior to magstripe application.

In some embodiments, the magstripe cavity may be formed using chemical etching, such as with ferric chloride or cupric chloride-based etchants. The rear surface of the metal sheet may first be coated with a photoresist layer, followed by UV exposure through a mask that defines the cavity geometry corresponding to the length, width, and position of a standard ISO magnetic stripe (typically 0.375 inches wide, centered approximately 0.223 inches from the top edge of the card). After development and exposure of the cavity region, the sheet is immersed in the etchant bath for a time calibrated to achieve the desired depth (e.g., typically between 0.002 and 0.004 inches) so that the magstripe can be fully seated into the resulting recess.

In alternate embodiments, the cavity may be created using laser ablation, micro-milling, or precision stamping, depending on the available equipment, the type of metal, and the scale of production. For example, fiber lasers with tight focus can selectively remove microns of material to create a precise trench without introducing mechanical stress or burrs. Similarly, CNC micro-milling may be used to route a shallow depression along the magstripe path for one-off or prototype runs. Regardless of the method used, the objective remains the same: to recess the metal just enough so that the magstripe, once embedded, sits flush with or below the adjacent metal surface, preserving a uniform topography across the card's rear face.

Once the cavity is prepared, a thin layer of adhesive (e.g., typically a heat-activated acrylic or polyurethane) may be applied within the recessed region. The magnetic stripe, whether in tape or inlay form, is then inserted into the cavity and cured under heat and pressure. Because the stripe is seated within the recessed metal, the finished card exhibits a completely smooth surface, with no elevated or exposed edges. This not only enhances durability and user experience but also allows the card to pass ISO bend, abrasion, and swipe tolerance tests with higher reliability.

In some implementations, the magstripe cavity may also be used to house decorative inlays, laser foils, NFC stickers, or other functional elements that would otherwise increase the surface height of the card. Moreover, the same technique may be extended to other regions of the card, such as signature panels, QR code recesses, or barcode labels, allowing for additional functional or aesthetic insertions without disrupting the card's planar form factor.

By integrating the magstripe cavity during the pre-singulation phase, illustratively at the same time as the card outlines and EMV cavities are chemically etched, production efficiency is increased and downstream CNC workload is reduced. No secondary routing or grinding is necessary post-assembly, and the alignment of the stripe relative to the card body remains locked in throughout the lamination and singulation process. This workflow provides both precision and repeatability, making it ideal for high-end metal cards in financial, access control, hospitality, and membership applications.

Specifically according to one or more embodiments herein, the invention enables the precise recessing of magnetic stripe cavities within metal card bodies to ensure compliance with ISO/IEC 7811 standards, which specify key physical characteristics of identification cards, including embossed characters, magnetic stripe placement, and mechanical properties. More specifically, ISO/IEC 7811-2 outlines dimensional tolerances for magnetic stripe tracks (Track 1, 2, and 3) and their placement on the card body. In particular, the standard mandates that the magnetic stripe be located 0.223 inches±0.010 inches from the top edge of the card and have a nominal width of 0.375 inches. To remain compliant with these specifications while incorporating the stripe into a metal card body, the cavity must be recessed with a tolerance-controlled depth (typically between 0.002″ and 0.004″) so that once installed, the magstripe lies flush with the rear surface of the card.

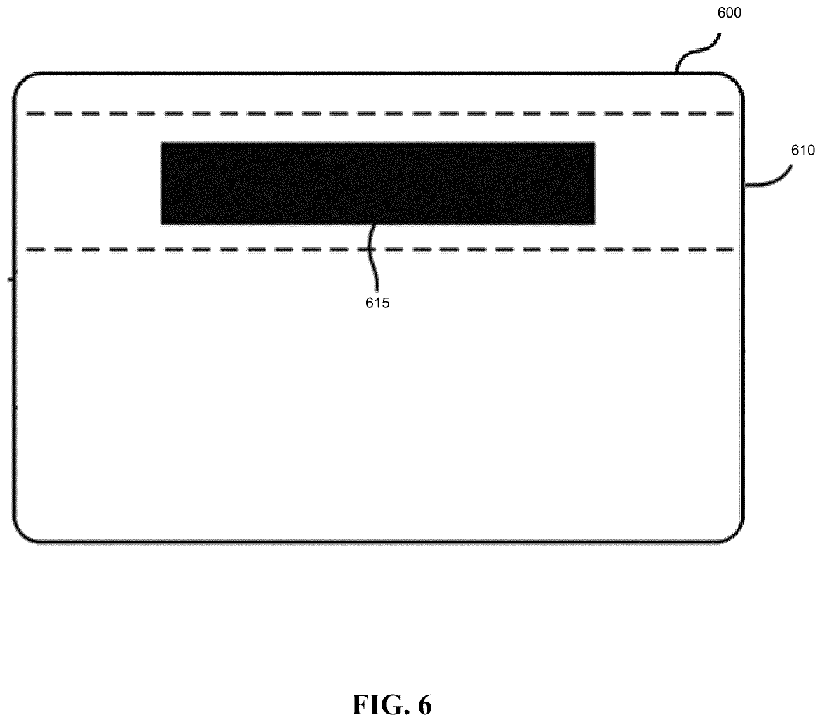

Referring now to FIG. 6, a representative view of a post-singulated metal card 600 is shown in which each card body includes a rear-side etched cavity 610 designated for the magnetic stripe 615. As illustrated, the recessed region is formed during the same etching stage as the card perimeter voids and module openings. The magstripe cavity is depicted as a longitudinal trench spanning the typical ISO-specified position. This cavity may be etched chemically, stamped mechanically, or ablated with a laser, depending on desired precision, sheet throughput, and the properties of the selected metal substrate. Once the stripe is seated into the cavity using a heat-activated or pressure-sensitive adhesive, the card maintains full rear-face planarity, a critical requirement for downstream lamination, personalization, and magnetic reader compatibility.

In a further embodiment, a similar approach is applied to the creation of the EMV chip module cavity, another common feature in dual-interface smartcards. According to ISO/IEC 7816-2 and 7816-3, the chip must be embedded within a module opening on the front face of the card at a standardized position and depth. Traditional manufacturing routes mill this cavity into the laminated card stack with CNC equipment. However, by chemically etching the cavity into the front metal sheet prior to lamination, the present disclosure reduces the need for mechanical cutting, minimizes tool wear, and maintains surface integrity.

Both the EMV chip cavity and the magstripe trench can be defined simultaneously using the same etching or cutting process during the initial template preparation step. Alignment holes or fiducials on the sheets ensure that both the front and rear cavities remain accurately registered with respect to each other when the sheets are laminated together. Moreover, in the case of dual metal-layer constructions (e.g., front and back stainless steel), this technique permits precise alignment and symmetric construction, resulting in superior flatness, balanced thickness, and consistent user experience.

The preparation of the magstripe cavity is thus a fully integrated stage in the production flow of the card. As outlined in the flowchart of FIG. 4 above, the cavity definition may be performed during the “Apply Chemical Etching or Stamping” step (step 402), alongside the perimeter tab voids and module opening. In FIG. 6, each card's magstripe trench is visible in the rear side of the sheet, allowing batch formation of multiple recessed regions across a 5×5 (25-up) or 4×4 (16-up) sheet layout. During final assembly (step 406 of FIG. 4), after lamination, singulation, and edge chamfering, the magstripe cavity is filled with adhesive and stripe stock, typically using automated tape applicators or manual insertion followed by curing, depending on production volume.

This integrated magstripe cavity process reduces post-lamination CNC tool paths and eliminates the risk of surface delamination due to adhesive lift or mechanical abrasion. By embedding the stripe below the surface, magnetic stripe longevity is improved while maintaining swipe compatibility with legacy readers. Additionally, the flat surface allows clear-coat films, laser-etched personalization, or UV printing to be applied over or adjacent to the stripe area without interruption or bubbling.

Regarding adhesives for magstripe cavity integration, once a magstripe cavity is defined (e.g., via chemical etching, stamping, or laser ablation), adhering the magstripe strip to the metal substrate requires a bonding solution that satisfies several constraints: thermal stability, chemical resistance, durability under flex and wear, and electrical isolation. There are two dominant classes of adhesive technologies used:
1. Heat-Activated Adhesives (HAA)
   Composition: Typically based on acrylic or polyester resins blended with tackifiers and plasticizers.
   Application: Pre-applied to the magstripe backing or dispensed directly into the cavity.
   Activation: Heat pressed at ˜120-180° C. for 2-10 seconds depending on metal type and cavity depth.
   Advantages: High bond strength; Resistant to solvents and oils (especially useful for cards used in commercial or hospitality settings); Allows for extremely thin application (<0.0015″/38 μm), preserving flush surface finish.
2. Pressure-Sensitive Adhesives (PSA)
   Composition: Rubber-based or acrylic-based tapes.
   Application: Often pre-laminated to the magstripe; the release liner is removed and pressed into place.
   Activation: Firm mechanical pressure (no heating).
   Advantages: Simplifies manual assembly or low-volume insertion; Low equipment requirements; Clean, residue-free, easily verifiable.
      Notably, both adhesives may also be combined with a UV-cured topcoat or protective film overlay to seal the cavity and extend lifecycle durability.

Once the adhesive is applied, or embedded directly onto the magstripe, the next step involves inserting the magstripe into the pre-etched cavity. Depending on production scale and application requirements, this step may be performed manually or through automated systems. In automated magstripe insertion, manufacturers employ custom magstripe applicators or multi-head insertion stations integrated into card lamination lines. These systems often include vision-guided alignment to ensure precise placement within cavity tolerances, with heated heads used to press the stripe into place when using heat-activated adhesives (HAA). Conveyor-based cooling zones are typically included to rapidly stabilize the adhesive bond, and the cavity itself is inspected for cleanliness using camera systems or air-knife mechanisms prior to insertion. This high-throughput setup can handle thousands of cards per hour, making it ideal for large-scale financial card production or premium high-volume product lines. Conversely, manual stripe insertion utilizes tools such as fixture jigs, handheld rollers, or precision tweezers. In this approach, operators manually clean each cavity, visually align the magstripe, and press it into position, potentially using a small heat press or handheld heat gun to activate the adhesive. Though slower and more labor-intensive, manual insertion allows for careful quality inspection of each individual card and is often preferred for custom orders, limited-run luxury cards, or prototyping in boutique manufacturing environments.

To create flush magstripe cavities without compromising card integrity, chemical etching is widely employed due to its superior precision and depth control. The process begins with masking, wherein a photoresist layer is applied to the metal sheet and the magstripe pattern is defined via ultraviolet (UV) exposure through a photomask. Depending on whether a positive or negative resist is used, the exposed or unexposed regions are then developed to reveal the underlying metal in the intended pattern.

Next comes etching, where carefully selected acid chemistries remove the exposed metal to create the cavity. Ferric chloride (FeCl₃) is commonly used for stainless steel and titanium, while cupric chloride (CuCl₂) may be employed for copper-backed substrates. Although nitric/hydrofluoric acid mixtures exist, their aggressive nature makes them less suitable for magstripe etching. Etching typically proceeds at controlled rates (e.g., approximately 0.001 inches per minute 0, with high-precision etch machines maintaining cavity depth within ±10 microns using timing and flow regulation.

Once the desired depth is achieved (commonly around 0.003 inches), the sheet undergoes etch stop and rinse. It is rinsed in deionized water and neutralized using an alkaline dip or similar method. Residual photoresist is then stripped, often with solvents or plasma ashing, to reveal the clean etched trench. Optionally, a surface passivation step may follow, applying a protective oxide layer or chemical primer to inhibit oxidation, enhance adhesive bonding, and ensure compatibility with downstream lamination or adhesive steps.

This pre-etch-and-insert approach offers significant advantages over traditional gluing of magstripes onto untreated surfaces. By creating a recessed cavity, the stripe lies flush with the card surface, eliminating unevenness and reducing the risk of rocking or bulging. Additionally, the etched trench walls enhance mechanical bonding strength and enable more secure stripe adhesion. The process also allows magstripe embedding to be integrated alongside other etching operations such as chip cavity formation and tab creation, streamlining overall card assembly. The result is a more durable, reliable product, with reduced risk of stripe peeling, edge chipping, or wear from repeated swipes at card readers.

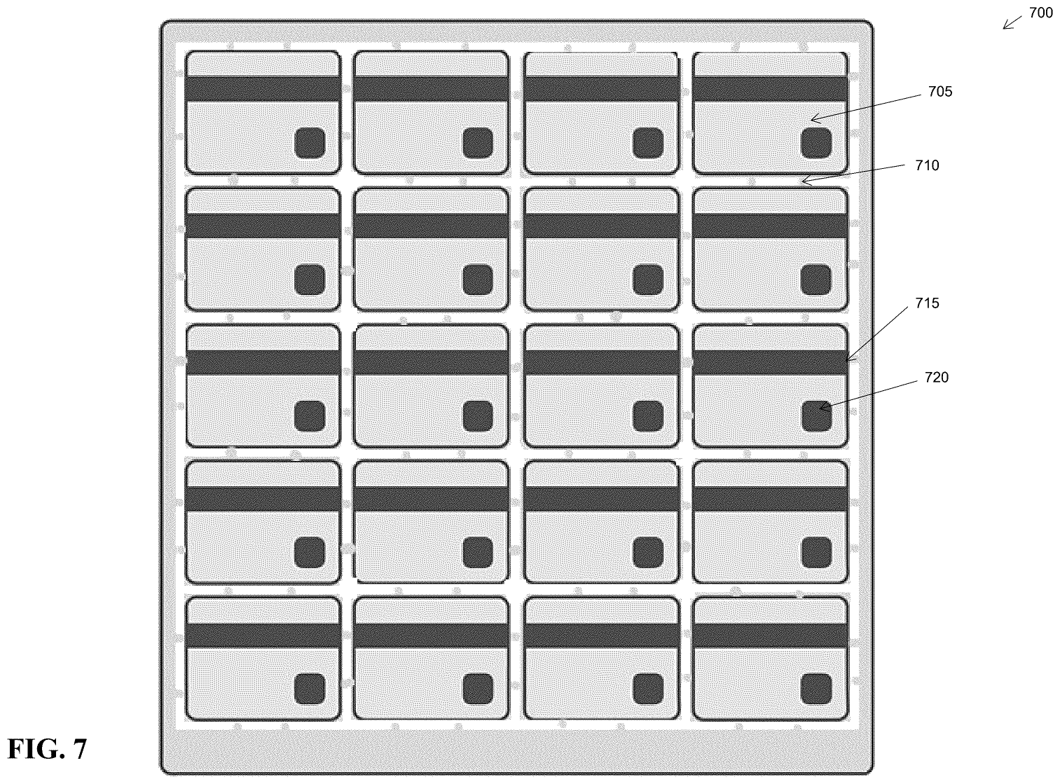

FIG. 7 depicts a pre-singulated card sheet template 700 comprising an array of twenty individual card outlines 705, arranged in a 4×5 grid layout, each partially singulated from adjacent card bodies using narrow card-to-card tabs 710. This embodiment illustrates how a full metal sheet may be configured for high-throughput production of metal transaction cards with embedded magstripe 715 and EMV chip features 720.

Each card outline is defined by a perimeter etch that partially severs the card from its neighbors, leaving strategically placed tabs at designated locations along opposing sides of the card perimeter. These tabs may be located on the lateral sides, top and bottom edges, or any corner of the card body, and are engineered to retain the structural integrity of the sheet during handling and downstream processing while enabling dual-edge milling during final singulation.

Within each card body, magstripe cavity regions are shown etched into the rear (typically upper or lower) half of the card. These cavities are recessed to accept a standard magnetic stripe such that the stripe will sit flush with the surrounding metal surface upon adhesive bonding. The magstripe cavity locations and depths conform to ISO/IEC 7811 standards, which govern magnetic stripe location, coercivity, and orientation.

Adjacent to or centered within the opposing half of each card, a chip cavity is also illustrated. This cavity is formed using chemical etching and may include a single-depth or stepped design suitable for EMV chip module insertion. These cavities align with ISO/IEC 7816 module specifications and are appropriately dimensioned to accommodate standard dual-interface chip modules.

The pre-singulated layout may further includes registration features (not shown) such as alignment holes or fiducials, disposed along the edges or corners of the sheet to facilitate precise stacking, lamination, or CNC toolpath registration during multi-layer bonding or cutting processes. These features allow multiple pre-etched sheets, such as a front metal layer and rear metal layer, to be laminated together with intervening adhesives, antennas, or dielectric films, then singulated in a final CNC pass that removes all card-to-card tabs and adds a chamfered edge.

The pre-fabricated sheet thus allows for a highly efficient production cycle where both functional recesses (magstripe and chip cavities) and card outlines are defined prior to final assembly and singulation. As a result, this configuration enables increased sheet yield, reduced material waste, minimal end-mill wear, and significant reductions in thermal distortion, surface marring, and production cycle times compared to traditional post-laminate CNC methods.

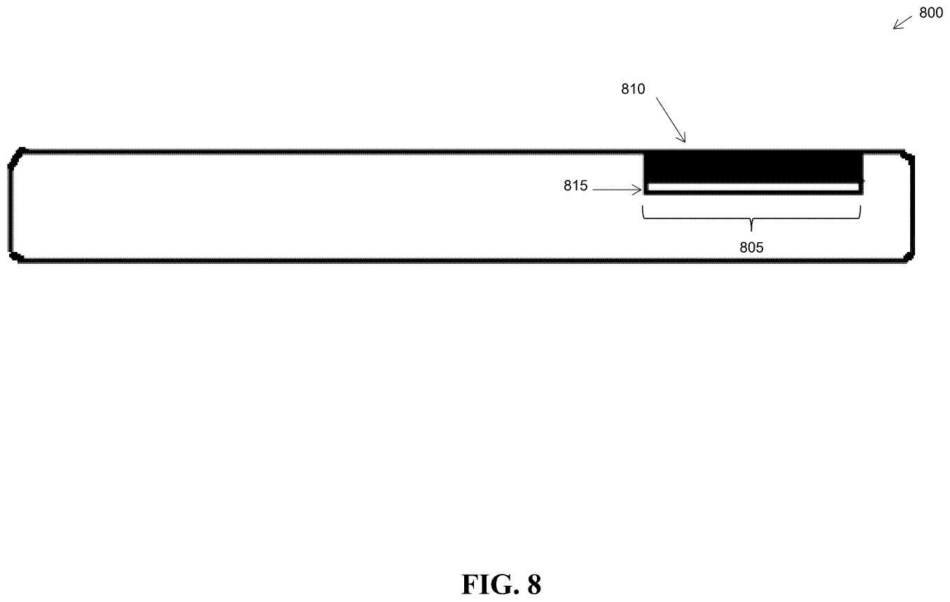

FIG. 8 illustrates an example side view of a metal transaction card body 800 that was chemical etched (region 805) for embedding a magnetic stripe 810 according to one or more embodiments of the present disclosure. In the illustrated embodiment, a metal card sheet is shown with a predefined magstripe cavity region (region 805). The magstripe cavity is formed by a controlled chemical etching process, wherein the metal in the cavity region is recessed to a precise depth, for example, approximately 0.003 to 0.006 inches, depending on the thickness of the magnetic stripe to be embedded. The etching may be performed using a masked photoresist process with a suitable etchant such as ferric chloride or cupric chloride, enabling fine dimensional control and smooth sidewall formation.

Adjacent to the etched cavity, an adhesive layer 815 is shown applied along the base surface of the cavity. The adhesive may be a heat-activated acrylic resin or a pressure-sensitive adhesive film, as previously described, selected to ensure strong bonding under operational stress and environmental exposure.

A magnetic stripe 810 is aligned above the etched cavity and pressed into position such that it seats flush with the surrounding surface of the metal card sheet. The insertion may occur through automated mechanical placement or manual alignment using jigs, with the adhesive layer forming a permanent bond once cured. In some embodiments, a topcoat or transparent overlay (not shown) may be laminated over the rear face of the card to protect the embedded magstripe and enhance durability.

The configuration shown in FIG. 8 ensures that the resulting rear surface of the card is substantially planar, eliminating raised or recessed features that could otherwise interfere with swiping, printing, or stacking. Moreover, because the cavity is precisely etched into the metal sheet before full card assembly, the embedded stripe does not compromise the structural integrity or aesthetic finish of the card.

Accordingly, the embodiment illustrated in FIG. 8 supports integration of magnetic stripe components into metal transaction cards with flush-fit surface geometry, strong adhesion, and enhanced resistance to peeling or delamination, while also facilitating high-speed automated processing and ISO compliance.

The foregoing description has set forth a variety of example embodiments, configurations, features, and implementation options. However, the scope of the present disclosure is not limited to those specific examples. Numerous alternative embodiments, modifications, and variations will be apparent to those of ordinary skill in the art in light of the present disclosure. By way of example, the following additional embodiments may also be encompassed within the scope of the invention.

In one alternate embodiment, the card outlines may be formed in a spiral, curved, or artistic layout rather than a rectangular grid. This allows for customized or non-rectilinear cards (e.g., round hotel keys or custom-cut membership tokens), all of which benefit from the same card-to-card tabbing and singulation efficiency.

In another embodiment, the geometry of each tab may vary, such as being straight-edged, semi-circular, or dog-bone shaped, depending on the intended CNC milling toolpath.

In another embodiment, perforations may be introduced along tab regions to further reduce the mechanical effort required for separation. These perforations may be created during the etching process or added later using mechanical punching.

In one variation, protective sacrificial layers may be laminated to the metal sheet prior to processing, then peeled away after final singulation. These may include polyolefin or polyester films used to prevent scratches during stacking, CNC machining, or transport.

In yet another embodiment, stacked sheets of differing materials may be combined. For example, a front stainless steel layer may be bonded to a titanium rear layer, with the card-to-card tabs etched into both. After bonding and curing, the combined template may be processed as a single unit.

Still further, the system may incorporate automated registration systems that align front and rear sheets using optical cameras or pin-based jigs. These systems may detect alignment holes or fiducial marks printed or etched into the sheets and adjust orientation accordingly prior to bonding or CNC milling.

In an alternative assembly flow, the front and rear metal layers may be pre-laminated individually, with inlays or chip elements encapsulated in resin, prior to final bonding into a unified card body. This “modular pre-lamination” process improves yield and enables parallel processing of front and rear components.

Some embodiments may utilize multi-head CNC systems with adjustable end mill diameters or dual-head chamfer tools. These systems allow for dynamic switching between cutting operations without removing the sheet from the machine bed, thus increasing throughput and minimizing alignment errors.

Lastly, the invention supports digital serialization or tracking by encoding alignment features or fiducials with unique laser markings, QR codes, or RFID stickers prior to singulation. These identifiers may persist post-singulation and be used for inventory, authentication, or personalization during card issuance.

Advantageously, the invention herein provides a novel card-to-card tabbing architecture that eliminates reliance on a surrounding frame, thereby maximizing sheet efficiency and reducing material waste. By interconnecting adjacent cards via edge tabs rather than suspending them from a perimeter, the template allows for significantly higher sheet utilization with virtually no excess metal between cards. This configuration enables dual-edge milling, whereby a single pass of a custom-configured CNC end mill can simultaneously separate and finish the adjoining edges of two neighboring cards, thereby reducing overall milling time by up to 75%. Additionally, this approach minimizes the volume of material removed, which in turn reduces tool wear and mitigates thermal buildup during machining, leading to improved durability of milling equipment and lower scrap rates. The invention is further advantageous in its universality, as it is compatible with various card configurations (e.g., including those with or without RFID slits, EMV cavities, magstripe cavities, printed layers, adhesives, or inlays) thereby offering broad applicability across multiple transaction card manufacturing workflows.

Conventional methods of manufacturing metal cards typically rely on a perimeter frame that surrounds each card and connects them to the larger metal sheet. These legacy techniques result in excess waste material due to the structural dependence on full-frame support, requiring that each individual card be isolated via four separate CNC milling passes—one for each edge. For a 4×4 array of 16 cards, this translates to 64 individual cuts. In contrast, the present invention introduces a card-to-card tabbing methodology that allows cards to be pre-singulated while still held in place by minimal struts between neighboring cards. This not only preserves the structural integrity of the sheet during processing but also reduces the total number of CNC cuts to just 60 for a 5×5 grid of 25 cards, demonstrating a 25% gain in cut-efficiency for an equivalent or larger batch.

The card-to-card approach also provides significantly improved sheet utilization. A traditional method using card-to-frame layouts on an 18″ by 13″ sheet with standard credit card dimensions (3.370″×2.125″) results in a maximum of 30 cards per sheet, 5 across the width and 6 down the height. This configuration consumes 91.81% of the total sheet area, leaving approximately 8.19% (or 19.16 square inches) as wasted space between and around the cards. By adopting the card-to-card pre-singulated layout, those gaps between cards are eliminated or minimized to only the strut tabs, enabling denser packing. This allows up to 39 cards to be produced from the same sheet area, a 30% increase in yield without increasing the raw material input.

Additionally, this design drastically reduces the cumulative edge length that must be milled. Since shared edges between adjacent cards only need to be milled once, rather than duplicated with full perimeter cutting, the cutting time is significantly reduced. For example, in a 25-card layout using card-to-card tabbing, only 60 cuts are required instead of the 100 needed if each card were fully surrounded by a frame. This results in faster production throughput, lower wear on cutting tools, and less heat generation during milling, leading to better edge quality and longer tool life. These improvements are not only quantifiable in terms of time and cost savings, but also reflect a more sustainable and resource-efficient manufacturing practice.

By enabling both a denser packing layout and shared-edge milling efficiency, this invention represents a substantial improvement over the prior art, which failed to consider or implement direct card-to-card tabbing systems. These prior solutions inherently constrained card design and layout options, resulted in higher scrap volumes, and forced extended milling durations for full card separation, barriers all eliminated by the disclosed approach.

Additionally, by providing for etched magstripe integration for metal transaction cards, such embodiments herein provide a refined method for integrating a magnetic stripe into metal transaction cards, offering a seamless, flush appearance and durable performance, addressing traditional challenges associated with attaching magnetic stripes to metal surfaces. Specific advantages may include: flush, seamless integration (by embedding the magstripe within an etched cavity, the card surface remains smooth and flush, improving the card's appearance and feel); enhanced durability (the embedded magstripe is less susceptible to peeling, wear, or damage compared to a surface-mounted magstripe, extending the card's lifespan); improved aesthetics and functionality (the seamless magstripe integration enhances the card's premium look, while the adhesive and etched cavity provide robust, reliable functionality); and compatibility with metal substrates (the etching and adhesive techniques are optimized for metal surfaces, offering an effective solution that addresses the limitations of traditional gluing methods).

According to one or more embodiments of the present disclosure, an illustrative apparatus (metal sheet template, i.e., a pre-singulated metal card template for transaction card production) herein may comprise: a metal sheet; and a plurality of card outlines formed within the metal sheet; each card outline defined by continuous etching along its perimeter except for a plurality of tab regions; wherein the tab regions interconnect adjacent card outlines directly to one another, except those tabs on cards of an outer perimeter that connect to an outer metal frame of the metal sheet.

In one embodiment, the tabs are positioned at midpoints or corners of shared edges between adjacent cards.

In one embodiment, the card outlines are formed by chemical etching, laser cutting, or stamping.

In one embodiment, at least one card outline includes a cavity for an EMV chip chemically etched into the metal sheet. In one embodiment, the template further includes a chemically etched cavity for a magnetic stripe on at least one card outline.

In one embodiment, the metal sheet supports at least 20 card outlines in a grid layout.

In one embodiment, the tabs are positioned along at least two opposing edges of each card outline.

In one embodiment, the tabs are positioned at corners of adjacent cards.

In one embodiment, each card outline is interconnected with at least two, and no more than eight, neighboring cards via respective tabs.

In one embodiment, the tabs are chemically etched into the metal sheet.

In one embodiment, the tabs have a cross-sectional width of less than 0.020 inches.

In one embodiment, the card outlines are arranged in a 5×5 grid.

In one embodiment, each card outline is oriented in portrait orientation.

In one embodiment, at least one card outline includes a chemically etched cavity for a magnetic stripe.

In one embodiment, the metal sheet comprises 304 stainless steel, titanium, or an aluminum alloy.

In one embodiment, the sheet includes a plurality of registration holes positioned at known locations relative to the card outlines.

In one embodiment, the template further comprises: a thermoset resin encapsulated within at least some of the cavities or voids between the tabs and the card outlines.

In one embodiment, each card outline is surrounded by contiguous adjacent cards, such that no edge of any card is adjacent to a support frame.

In one embodiment, the metal sheet has a thickness of at least 0.012 inches.

According to one or more embodiments of the present disclosure, an illustrative method for producing metal transaction cards herein may comprise: providing a metal sheet; chemically etching outlines of a plurality of cards in the metal sheet to define each card perimeter, leaving tabs between adjacent cards; chemically etching cavities for at least one of an EMV chip or a magnetic stripe in designated regions of each card; laminating or bonding the metal sheet to one or more additional layers to form a card assembly; and using a CNC tool to mill away the tabs and separate individual cards from the sheet.

In one embodiment, the tabs are positioned between adjacent cards such that a single CNC tool pass removes material from both card edges simultaneously.

In one embodiment, the method further comprises: aligning a second metal sheet to the first sheet via alignment holes and bonding the sheets to form a double-sided card body.

In one embodiment, chamfered edges are applied during tab removal to smooth the card edges.

In one embodiment, the chemical etching step comprises masking the metal sheet with a photoresist, exposing the photoresist with a patterned image of the card outlines, developing the photoresist to reveal etch zones, and submerging the sheet in a ferric chloride or cupric chloride etchant.

In one embodiment, the method further comprises: flipping the metal sheet and performing a second chemical etch from the opposing side.

In one embodiment, the lamination step includes bonding a rear metal sheet to the front metal sheet with a printed antenna layer and adhesive stack positioned in between.

In one embodiment, the method further comprises: applying a thermoset resin to fill voids between card outlines and allowing the resin to cure before CNC milling.

In one embodiment, the CNC milling step comprises simultaneously removing tab material from two adjacent card edges in a single toolpath.

In one embodiment, the method further comprises: applying a chamfer to at least one edge of each singulated card during the tab removal step.

In one embodiment, the adhesive layer comprises an acrylic or polyurethane hot-melt adhesive activated by heat and pressure.

In one embodiment, the method further comprises: printing a visual design on the metal sheet prior to singulation.

In one embodiment, the method further comprises: embedding an EMV chip in the chemically etched chip cavity using a standard thermal embedding tool.

In one embodiment, the method further comprises: embedding a magnetic stripe into the chemically etched magstripe cavity using a pressure-sensitive adhesive.

In one embodiment, the singulated cards are used as payment cards, access control credentials, identification badges, or promotional display cards.

According to one or more embodiments of the present disclosure, an illustrative pre-singulated metal card sheet herein may comprise: a metal substrate having a plurality of card-shaped voids chemically or mechanically formed therein, the voids defining individual card perimeters; each card-shaped void being separated from adjacent voids by at least one narrow tab extending between adjacent card edges such that each card is connected only to one or more other cards via the tabs, except those tabs on cards of an outer perimeter that connect to an outer metal frame of the metal sheet; and wherein the tabs are configured to permit mechanical separation of individual cards via CNC milling or other cutting operation along shared edges.

In one embodiment, the metal substrate comprises stainless steel, titanium, aluminum, copper, or a laminate thereof.

In one embodiment, each card-shaped void conforms to ISO/IEC 7810 ID-1 dimensions.

In one embodiment, the pre-singulated metal card sheet further comprises: fiducial alignment holes positioned in corners of the sheet for CNC registration.

In one embodiment, the tabs are positioned on opposing sides of adjacent voids to enable dual-edge milling passes.

In one embodiment, at least one card-shaped void includes a recessed cavity for an EMV chip, the cavity having a rectangular shape with rounded corners.

In one embodiment, the card-shaped voids are arranged in a repeating 5×5 grid with inter-card tabs on all adjacent sides, and wherein the sheet includes no frame between outer cards and the sheet boundary.

According to one or more embodiments of the present disclosure, an illustrative method of manufacturing metal cards herein may comprise: etching a plurality of card-shaped voids into a metal sheet, each void corresponding to a card perimeter and connected to adjacent voids by one or more removable tabs, the voids arranged in a grid such that tabs are positioned only between adjacent cards except for tabs along an outer perimeter of cards that connect to an outer metal frame of the metal sheet; milling along shared edges of adjacent voids to separate individual cards while preserving a majority of the sheet structure; and post-processing the individual cards to receive surface features, including at least one of chip cavities, magstripe cavities, or graphical treatments.

In one embodiment, the etching step comprises applying a photoresist, exposing a photomask, and using a chemical etchant selected from ferric chloride, cupric chloride, or nitric/hydrofluoric acid mixtures.

In one embodiment, the milling step uses a CNC end mill sized to fit between adjacent voids and simultaneously separate two card edges.

In one embodiment, method further comprises: aligning multiple etched sheets and adhering them together prior to milling to form a multi-layered card.

In one embodiment, a cavity for a magnetic stripe is pre-etched into the card surface to a depth such that the stripe lies flush with the surrounding metal after insertion. In one embodiment, the method further comprises: inserting the magnetic stripe using an automated applicator with vision-guided placement and heated adhesive activation.

In one embodiment, the tabs between card-shaped voids are between 0.3 mm and 1.5 mm in width and are chemically thinned to facilitate breakaway or precision cutting.

In one embodiment, the individual cards are post-processed by filling edge voids or chip cavities with thermoset resin prior to final edge finishing.

According to one or more embodiments of the present disclosure, an illustrative metal card manufactured from a pre-singulated card-to-card tabbed sheet herein may comprise: a perimeter corresponding to a card-shaped void originally defined within the sheet; at least one edge having been separated from an adjacent card by removal of a tab via a CNC milling operation; and a recessed cavity formed in the card surface prior to singulation, the cavity being configured to receive a magnetic stripe such that an outer surface of the stripe lies flush with the surrounding metal surface of the card.

In one embodiment, the magnetic stripe is adhered using a heat-activated adhesive applied to a recessed cavity etched to a depth between 0.002 and 0.005 inches.

In one embodiment, the card further comprises a layered construction including a printed polymer or decorative inlay adhered to the metal substrate.

In one embodiment, at least one surface of the card includes a resin-filled cavity created prior to singulation, and wherein the resin was cured before milling.

In one embodiment, the card edges have a chamfered or radiused profile resulting from CNC cutting tools applied along shared tabbed edges.

According to one or more embodiments of the present disclosure, an illustrative method for forming a magnetic stripe cavity in a metal transaction card herein may comprise: receiving a metal sheet comprising a front side and a rear side; selecting a designated region of the metal sheet corresponding to a magnetic stripe location compliant with ISO/IEC 7811; and etching a cavity into the designated region to a predetermined depth less than the thickness of the metal sheet, such that the cavity is recessed relative to a surrounding surface of the metal sheet; wherein the cavity is dimensioned to receive a magnetic stripe such that, upon embedding, the magnetic stripe resides flush with the surrounding surface of the metal sheet.

In one embodiment, the magnetic stripe cavity is chemically etched using a photolithographic masking process and a metal etchant selected from the group consisting of ferric chloride, cupric chloride, and nitric acid.

In one embodiment, the cavity for the magnetic stripe is etched prior to assembly of the card into a laminated construction.

In one embodiment, the etched magnetic stripe cavity is filled with a heat-activated adhesive before embedding the magnetic stripe.

In one embodiment, the method further comprises: aligning and laminating a second metal sheet with the etched sheet, and wherein the magnetic stripe cavity remains accessible after lamination for insertion of the magnetic stripe.

In one embodiment, the magnetic stripe is inserted into the cavity using an automated applicator configured to apply uniform pressure during the embedding process.

According to one or more embodiments of the present disclosure, an illustrative pre-singulated metal card template for transaction card production may comprise: a metal sheet with partially etched or stamped card outlines, each card defined by a perimeter with small tabs to retain the cards within the sheet during assembly.

In one embodiment, the pre-singulation is achieved through chemical etching, stamping, or laser cutting, creating a defined outline with minimal tab connections for each card.

In one embodiment, the template comprises: pre-etched cavities for embedding an EMV chip and magnetic stripe, reducing the need for post-assembly milling.

In one embodiment, the final singulation process uses CNC milling to remove the tabs and add chamfered edges, completing individual card separation.

In one embodiment, each metal layer maintains a minimum thickness of 0.012 inches, achieving a total metal thickness of at least 0.024 inches to meet ISO standards.

According to one or more embodiments of the present disclosure, an illustrative method for producing pre-singulated transaction cards may comprise: selecting a metal sheet for the card template; partially singulating each card within the sheet by etching or stamping an outline and leaving small tabs; chemically etching cavities for an EMV chip and magnetic stripe in designated areas of each card; and CNC milling the tabs to fully singulate each card from the sheet.

In one embodiment, minimal coolant is used during CNC milling to prevent overheating and warping of the metal.

According to one or more embodiments of the present disclosure, an illustrative method for integrating a magnetic stripe into a metal transaction card may comprise: etching a cavity into the metal card's surface to accommodate the magnetic stripe; applying an adhesive within the etched cavity; and embedding the magnetic stripe within the adhesive-coated cavity, ensuring the stripe sits flush with the card surface.

In one embodiment, the depth of the etched cavity is calibrated to match the thickness of the magnetic stripe, providing a seamless integration into the card's surface.

In one embodiment, the adhesive is selected for its resistance to temperature variations, environmental exposure, and frequent handling, ensuring long-term durability of the embedded magnetic stripe.

In one embodiment, the method further comprises a curing process to secure the adhesive bond between the magnetic stripe and the metal card surface.

In one embodiment, the adhesive layer within the etched cavity is applied to achieve even coverage and a secure bond between the magnetic stripe and the card.

In one embodiment, the cavity is created using chemical etching or laser engraving, allowing for precise control over the depth and dimensions of the magnetic stripe area.

According to one or more embodiments of the present disclosure, an illustrative metal transaction card with an integrated magnetic stripe may be produced by the method above, wherein the magnetic stripe is embedded within an etched cavity and bonded to the card using adhesive, creating a flush and durable surface.

While there have been shown and described illustrative embodiments, it is to be understood that various other adaptations and modifications may be made within the scope of the embodiments herein. For example, the embodiments may, in fact, be used in a variety of types of information cards, such as payment cards, transaction cards, credit cards, debit cards, gift cards, identification cards, loyalty cards, transit cards, access cards, and so on, and the use of the terms “smartcard” or “transaction card” are not meant to be limiting to the scope of the disclosure. In various embodiments, the present disclosure may relate to industrial and commercial industries, such RFID applications, payment smartcards, and other. Furthermore, while the embodiments may have been demonstrated with respect to certain communication protocols, physical dimensions, or card reader devices and form factors, other configurations may be conceived by those skilled in the art that would remain within the contemplated subject matter of the description above.

It should be noted that while certain steps within procedures described above may be optional and the steps shown or described are merely examples for illustration, and certain other steps may be included or excluded as desired. Furthermore, while a particular order of the steps is shown, this ordering is merely illustrative, and any suitable arrangement of the steps may be utilized without departing from the scope of the embodiments herein.

It will also be apparent to those skilled in the art that various processor and memory types, including various non-transitory computer-readable media, may be used to store and execute program instructions pertaining to certain aspects of the techniques described herein, including operating machinery required to produce the products described herein. Also, while the description illustrates various processes, it is expressly contemplated that various processes may be embodied as software, hardware, and/or firmware modules configured to operate in accordance with the techniques herein (e.g., according to the functionality of a similar process). Further, while processes and/or products herein have been shown separately, those skilled in the art will appreciate that such processes and/or products may be combined in any suitable combination(s) herein.

Furthermore, in the detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or specifics have not been described in detail so as not to obscure the discussion.

In particular, the foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method as described above.

2. An apparatus as described above.

3. A metal card as described above.
